(19) United States
(12) Patent Application Publication
(10) Pub. No.: US 2008/0260401 A1
(43) Pub. Date: Oct. 23, 2008

(54) IMAGE FORMING APPARATUS

(75) Inventor: Hiromitsu SHIMAZAKI, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/843,254

(22) Filed: Aug. 22, 2007

(30) Foreign Application Priority Data
Aug. 31, 2006 (JP) 2006-235234

(51) Int. Cl. G03G 15/16

(52) U.S. Cl. 399/66

(57) ABSTRACT

An image forming apparatus has a photo-conductor drum that bears a toner image, and a transfer roller that is rotated in contact with the photo-conductor drum. The transfer roller transfers the toner image borne on the photo-conductor drum onto a recording medium conveyed between the photo-conductor drum and the transfer roller. The image forming apparatus includes a controller for applying to the transfer roller a transfer bias voltage for transferring the toner image from the photo-conductor drum onto the recording medium. The transfer bias voltage is a convolution of DC component and AC component.

### BACKGROUND

The present invention relates to an image forming apparatus that provides an excellent print quality with less transfer unevenness, white patch and fogging by controlling the voltage of a transfer roller, and more particularly to an image forming apparatus having a high print quality in the double-sided printing.

In an image forming apparatus such as a copier, a printer, a multi-functional machine or a facsimile apparatus using the electrophotographic technology, a transfer device with a transfer roller is widely used. This transfer device involves uniformly charging a photo-conductor with a charger unit, scanning the surface of this photo-conductor by a laser beam modulated with an image signal to form an electrostatic latent image, transferring and depositing the toner onto the photo-conductor on which the electrostatic latent image is formed to make a visible image (hereinafter a toner image), further conveying the recording medium between the photo-conductor and the transfer roller while applying a transfer bias voltage to the transfer roller, and transferring the toner image on the photo-conductor onto the recording medium. This transfer bias voltage is applied to transfer the toner image onto the recording medium by supplying charges having opposite polarity to the toner from the back side of the recording medium.

Conventionally, to make the excellent transfer, it was required to flow a current within a predetermined range in passing the recording medium, whereby a control method such as constant current control or constant voltage control was properly employed according to the function of the device.

FIG. 6 is a constitutional view of the conventional transfer device with constant voltage control.

In FIG. 6, reference numeral 101 denotes a photo-conductor drum, reference numeral 102 denotes a transfer roller, reference numeral 103 denotes a recording medium, reference numeral 104 denotes a non-magnetic one-component toner, and reference numeral 105 denotes a transfer bias control circuit. The toner 104 supplied from a toner supply roller, not shown, is negatively charged frictionally by a toner regulation blade, and transferred and deposited onto the electrostatic latent image on the photo-conductor drum 101 to visualize it. The recording medium is passed in perfect timing for the photo-conductor drum 101, and the back surface of the recording medium 103 is rendered in opposite polarity by applying a positive DC voltage of the transfer bias control circuit 105 to the transfer roller 102. Thereby, the toner image of the photo-conductor drum 101 is transferred onto the recording medium 103. Thereafter, the toner image is fixed by heat and pressure of a heat roller and a pressure roller in a fixing unit, not shown.

However, when the constant voltage control is performed, a transfer failure may occur due to insufficient transfer current in the low temperature and low humidity environment, if a voltage, for example, 500V, suitable to achieve the excellent transfer under the ordinary temperature and ordinary humidity is applied. Thus, if an applied voltage is set to achieve the excellent transfer in the low temperature and low humidity environment, fogging may occur in the ordinary temperature and ordinary humidity environment, and the high temperature and high humidity environment. To avoid this contradiction, the constant current control is adapted, but there is a problem that when the toner image is transferred onto the recording medium having narrow width, a current density is increased in a non-image area, and a voltage of the transfer roller falls, causing a transfer failure due to another factor.

Therefore, the following image forming apparatus was offered to achieve the stable transfer ability on the recording medium of various sizes in various environments (refer to patent document 1). This image forming apparatus performs the constant current control for the transfer roller, if a nip part is in the non-image area (beyond the size), to hold the voltage at this time, or performs the constant voltage control at this held voltage if the nip part is in the image area (within the size).

Similarly, a color image forming apparatus was offered in which the constant voltage control is performed for the transfer roller, and electrostatic separation is performed for a separation brush with a separation bias voltage containing a DC component and an AC component (refer to patent document 2). However, this is limited to the case that the drum diameter of the photo-conductor drum is 70 mm or greater, or the radius of curvature in the nip part is 35 mm or greater.

[Patent document 1] JP-A-2-123385

[Patent document 2] JP-A-7-98548

The image forming apparatus of patent document 1 provided the stable transfer ability with less fogging on the recording media of various widths in various environments, but it was required that the control method was changed depending on whether the nip part is in the image area (within the size) or the non-image area (beyond the size), whereby the control was complex and the high print quality could not be achieved.

Also, the image forming apparatus of patent document 2 performs the constant voltage control for the transfer roller, and makes the electrostatic separation by applying a separation bias voltage to the separation brush, in which the consistency between the transfer and the separation is achieved in a color inherent process for superposing the toner image on the photo-conductor drum. That is, this is the control specific to the color image forming apparatus, and the control for the separation brush is increased so that the overall control is more complex.

In this manner, the image forming apparatus of patent document 1 or 2 can cope with the printing environment or the color characteristics, but does not improve the print quality in consideration of the toner property itself. Generally, the toner is charged negatively or positively in a predetermined charged polarity due to frictional charging with each charging member, but because the disintegration or pulverization occurs due to collision between toner particles during the agitation, such particles may be charged in opposite polarity and mixed as the foreign matter into the toner (some of the toner is charged in opposite polarity.) Fine particles such as fractured toner or chip toner among such particles cause the transfer unevenness, white patch or fogging. FIG. 7 is an explanatory view showing agitation in the toner bottle.

In FIG. 7, reference numeral 104a denotes a particle such as positively (opposite polarity) charged toner, reference numeral 104b denotes a fine particle such as toner chip, reference numeral 106 denotes a toner bottle, and reference numeral 107 denotes a toner agitation member. The toner agitation member 107 is rotated in synchronism with the toner supply roller to negatively charge the toner as well as prevent coagulation of the toner 104, to move the toner to the toner supply roller 6. At this time, the toner 104 should be negatively charged uniformly, but some of the toner is positively charged frictionally as the particle 104a of foreign matter, or there is fine particle 104 as fractured toner or its chip by the agitation.

Accordingly, if the toner image is formed by such toner 104, the large positive particle 104a does not adhere to the photo-conductor drum 101, but the fine particle 104b may adhere and be transferred onto the recording medium. And the chip of fractured toner 104 may float and adhere to other than the image area. This is one of the causes for producing the white patch, transfer unevenness and fogging, and degrading the print quality.

Also, in the double-sided printing, the printing is performed on one side of the recording medium and then on the other side, but the firstly printed image might degrade the print quality when the printing is performed on the remaining face. The conventional image forming apparatus of patent document 1 or 2 does not solve the problem with the print quality that may arise in the double-sided printing.

### SUMMARY

Thus, it is an object of the invention to provide an image forming apparatus that can form the favorable image having the excellent print quality with less transfer unevenness, white patch and fogging, and the high print quality in the double-sided printing.

The present invention provides an image forming apparatus that has an image bearing member and a transfer roller. The photo-conductor drum bears a toner image. The transfer roller is rotated in contact with the image bearing member, and transfers the toner image borne on the image bearing member onto a recording medium conveyed between the image bearing member and the transfer roller. The image forming apparatus includes a controller for applying to the transfer roller a transfer bias voltage for transferring the toner image from the image bearing member onto the recording medium. The transfer bias voltage is a convolution of DC component and AC component.

### BRIEF DESCRIPTION OF THE DRAWINGS

FIG. 1 is a constitutional view of an image forming apparatus according to an embodiment 1 of the present invention.

FIG. 2 is an explanatory view showing the constitution of a main part of the image forming apparatus according to the embodiment 1 of the invention.

FIG. 3A is an explanatory view for explaining the operation when a transfer bias voltage that is convolution of DC component and AC component is applied to the image forming apparatus according to the embodiment 1 of the invention and FIG. 3B is an explanatory view for explaining the operation when a transfer bias voltage of DC component is applied to the image forming apparatus of FIG. 3A.

FIG. 4 is a view showing the relationship between the rubber hardness and the transfer efficiency of the transfer roller.

FIG. 5A is an explanatory view for explaining the operation when a transfer bias voltage that is convolution of DC component and AC component is applied to an image forming apparatus according to an embodiment 2 of the invention and FIG. 5B is an explanatory view for explaining the operation when a transfer bias voltage of DC component is applied to the image forming apparatus of FIG. 5A.

FIG. 6 is a constitutional view of the conventional transfer device under the constant voltage control.

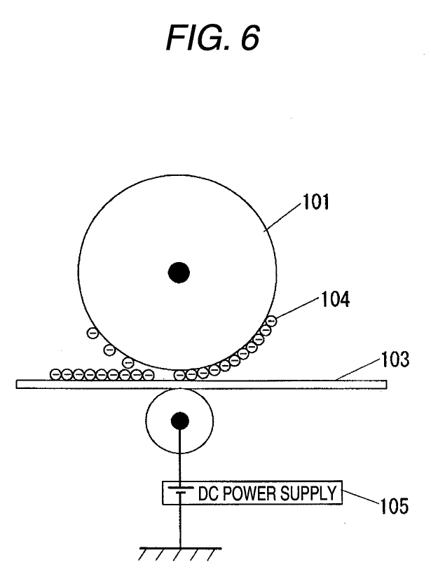

FIG. 7 is an explanatory view showing how the agitation is made in the toner bottle.

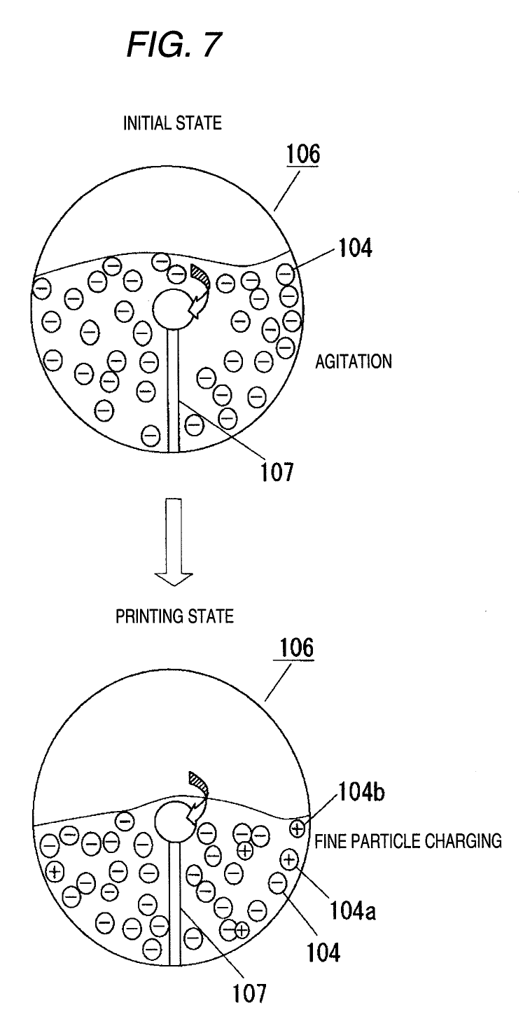

### DETAILED DESCRIPTION

### Embodiment 1

An image forming apparatus according to an embodiment 1 of the present invention will be described below in detail with reference to the accompanying drawings. The image forming apparatus of the invention forms the image through an electrophotographic process, or transfers the image formed using the toner, such as a printer, a copier or a multi-functional machine.

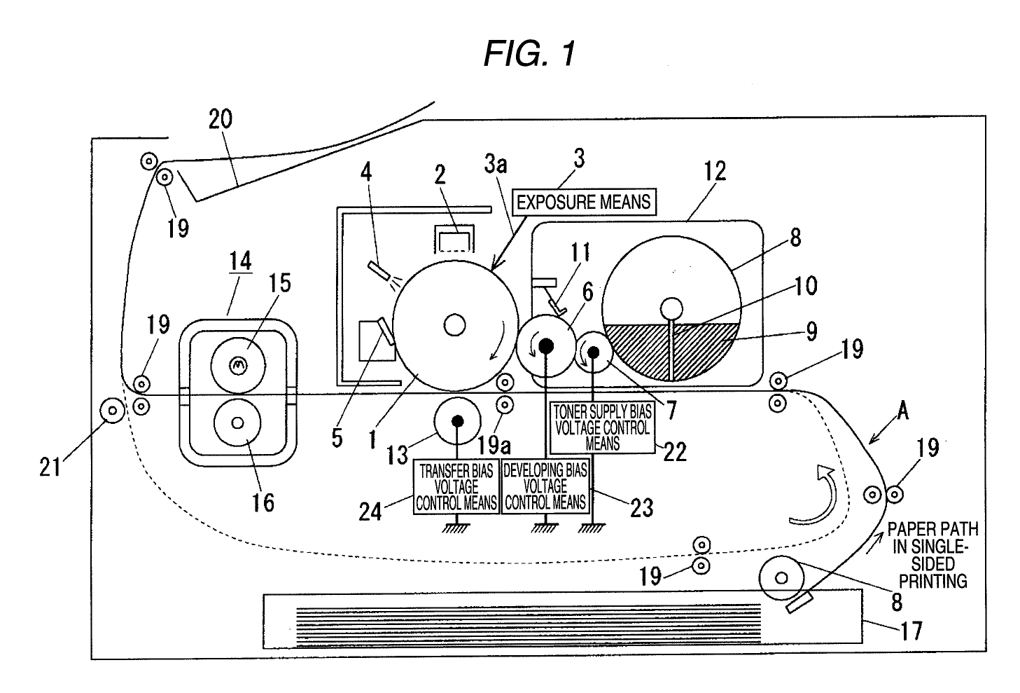

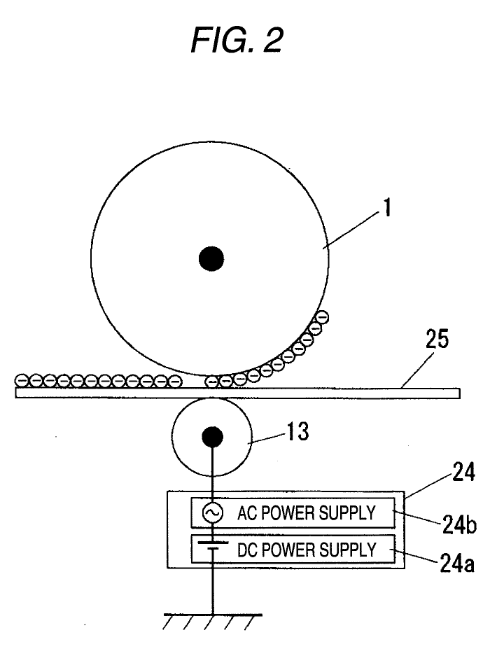

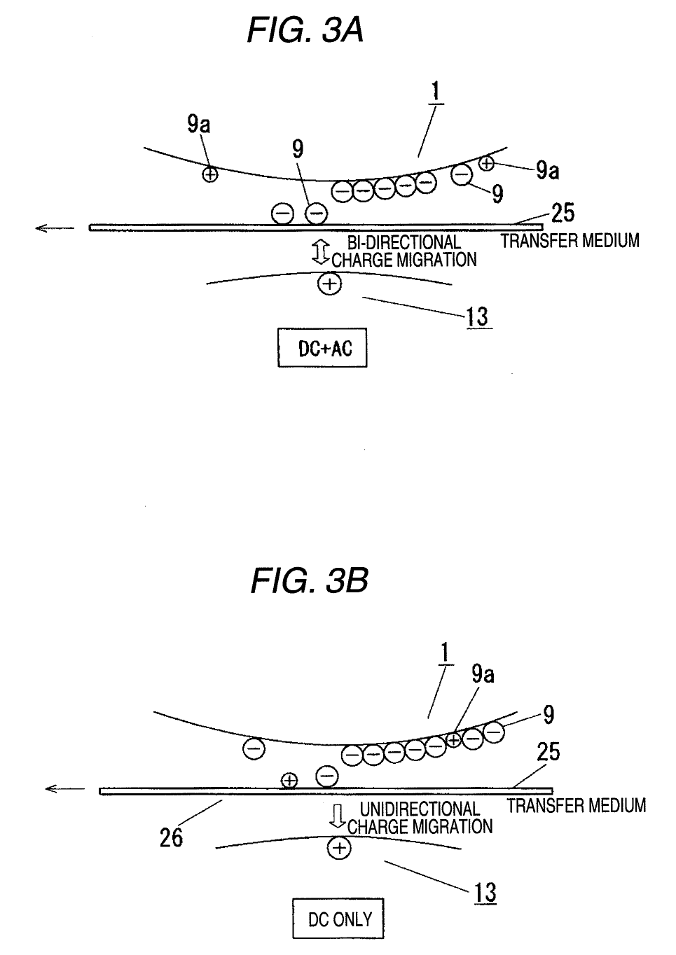

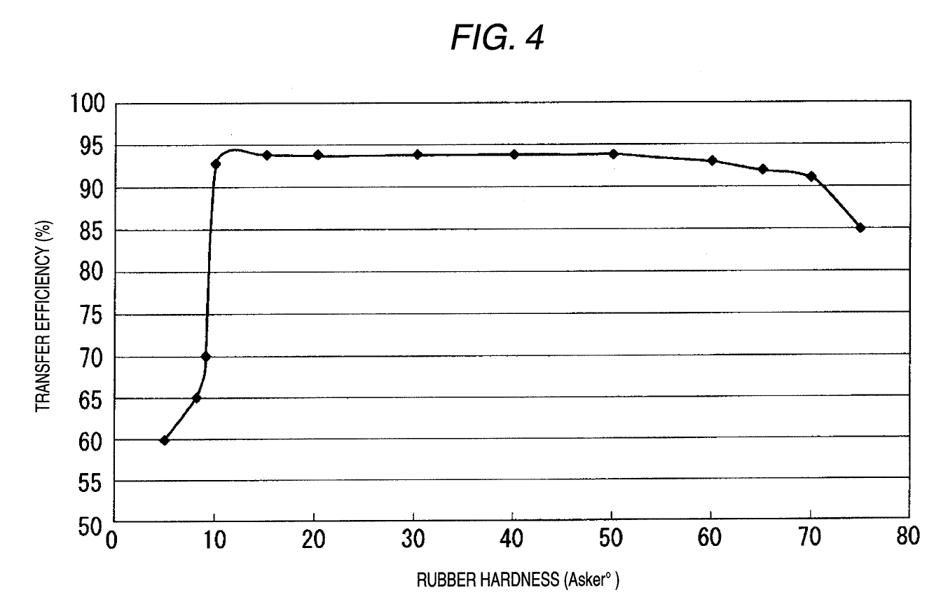

FIG. 1 is a constitutional view of an image forming apparatus according to an embodiment 1 of the invention. FIG. 2 is an explanatory view showing the constitution of a main part of the image forming apparatus according to the embodiment 1 of the invention. FIG. 3A is an explanatory view for explaining the operation when a transfer bias voltage that is convolution of DC component and AC component is applied to the image forming apparatus according to the embodiment 1 of the invention, and FIG. 3B is an explanatory view for explaining the operation when a transfer bias voltage of DC component is applied to the image forming apparatus of FIG. 3A. FIG. 4 is a view showing the relationship between the rubber hardness and the transfer efficiency of the transfer roller.

The image forming apparatus of the embodiment 1 can perform the single-sided printing, but may not perform the double-sided printing. In the following, the image forming apparatus capable of double-sided printing will be described in the case of single-sided printing. The details of the image forming apparatus in the double-sided printing will be described later in an embodiment 2. In the embodiment 1, the single-sided printing is treated. Herein, a conveying path A of the image forming apparatus as shown in FIG. 1 conveys the recording medium such as the copy paper in the single-sided printing, and a conveying path B is used for the double-sided printing to reverse and insert the recording medium outputted onto a paper output tray in the double-sided printing.

In FIG. 1, reference numeral 1 denotes a photo-conductor drum (image bearing member of the invention) for forming an electrostatic latent image, in which a photosensitive layer is formed on the outer peripheral surface of a metallic drum made of aluminum or the like. Reference numeral 2 denotes a charger unit, which is disposed near the photo-conductor drum 1, for uniformly charging the photo-conductor drum 1 by corona discharge. Reference numeral 3 denotes exposure means such as a laser diode, and reference numeral 3a denotes a light beam such as a laser beam radiated from the exposure means 3. The exposure means 3 generates a light beam 3a by modulating an image signal in a drive circuit of the exposure means 3, based on the image signal acquired by an image sensor, or the image signal such as recorded data, and scans the surface of the photo-conductor drum 1 by this light beam to form an electrostatic latent image.

Reference numeral 4 denotes a static eliminator for eliminating the static electricity by applying the light, and reference numeral 5 denotes a cleaning blade for scraping off the residual toner remaining on the surface of the photo-conductor drum 1. Also, reference numeral 6 denotes a developing roller that is a toner carrier, and reference numeral 7 denotes a toner supply roller for supplying the negatively charged toner 9 onto the surface of the developing roller 6, in which the developing roller 6 and the toner supply roller 7 are provided in contact. A toner supply bias voltage that is convolution of DC component and AC component is applied to the toner supply roller 7 by toner supply bias voltage control means 22 (hereinafter described), and a developing bias voltage of constant DC voltage is applied to the developing roller 6 by developing bias voltage control means 23 (hereinafter described).

Further, reference numeral 8 denotes a toner bottle, reference numeral 9 denotes a toner, and reference numeral 10 denotes a toner agitation member for agitating the toner 9. Also, reference numeral 11 denotes a toner regulation blade, and reference numeral 12 denotes a developer unit for storing the toner bottle 8, the developing roller 6 and the toner supply roller 7. The toner 9 of the embodiment 1 is a non-magnetic, one-component toner, in which carbon, wax and a static control agent are uniformly dispersed in polyester resin. The toner is agitated by the toner agitation member 10 and negatively changed.

Also, the developing roller 6 is supported rotationally at both ends of the developer unit 12, and formed with a conductive elastic member, for example, a silicon rubber layer around the outer periphery of a metallic shaft. The metallic shaft of the developing roller 6 is connected to a constant voltage power supply. Similarly, the toner supply roller 7 is also formed with a conductive elastic foam around the periphery of a metallic shaft, which is connected to a toner supply bias power supply. This toner supply bias voltage is convolution of DC component and AC component, whereby the toner supply roller 7 can supply the toner 9 supplied from the developer unit 12 to the developing roller 6, and the toner 9 on the developing roller 6 that remains without being developed can be effectively scraped off.

The toner 9 supplied by the toner supply roller 7 forms a thin toner layer on the outer peripheral face of the developing roller 6 owing to the toner regulation blade 11. The toner regulation blade 11 is composed of a metallic plate spring and an elastic member of urethane rubber or silicone rubber at one end thereof, and presses the developing roller 6 at a line pressure of about 80 g/cm to form a toner layer on the surface of the developing roller 6. This developing roller 6 is disposed in contact with the photo-conductor drum 1, whereby the toner 9 on the toner layer is transferred and deposited on a part where the electrostatic latent image is formed on the photo-conductor drum 1 by a bias voltage applied by the developing bias voltage means 22 to visualize the electrostatic latent image as a toner image.

By the way, the transfer device of the embodiment 1 will be described below. In FIG. 1, reference numeral 13 denotes a transfer roller rotating in contact with the photo-conductor drum 1. The transfer roller 13 is formed with a conductive elastic foam, viz., a silicon rubber layer having a rubber hardness of 10° to 60° in Asker C in the embodiment 1, around the outer periphery of a metallic shaft made of stainless or the like. A positive voltage having the opposite polarity to the toner 9, which is convolution of DC component and AC component, is applied to the metallic shaft of this transfer roller 13 by the transfer bias voltage control means 24, so that the toner image on the photo-conductor drum 1 is transferred onto the recording medium. The details thereof will be described later.

In the embodiment 1, with the constitution of this transfer roller 13 as described above, the nip width between the photo-conductor drum 1 and the transfer roller 13 is made from 1 mm to 20 mm. With this setting, a variation in the electric field due to AC component prevents the positively charged fine particle 9a such as fractured toner 9 or its chip from adhering to the photo-conductor drum 1 and the image area on the recording medium, and restores the fractured toner or its chip to the photo-conductor drum 1, even if the fine particle floats and adheres to the non-image area on the recording medium, whereby it is possible to realize the suitable relationship between the photo-conductor drum 1 and the transfer roller 13, and improve the print quality by preventing the white patch, unevenness of printing, and fogging. The specific control therefor will be described later.

In FIG. 1, reference numeral 14 denotes a fixing device, reference numeral 15 denotes a heat roller that is internally provided with a heat source such as a halogen lamp, and reference numeral 16 denotes a pressure roller pushed against the heat roller 15 and formed with a rubber layer or a sponge layer on the surface. The pressure roller 16 is pushed against the heat roller 15 by a spring or the like.

Also, reference numeral 17 denotes a paper feed tray that stacks the recording media such as paper, reference numeral 18 denotes a pickup roller for picking up the recording medium with a partition plate and carrying in the recording medium one by one from the paper feed tray 17 onto the conveying path A, and reference numeral 19 denotes a conveying roller. And reference numeral 19a denotes a registration roller for temporarily stopping the recording medium in standby to align the recording medium with the toner image on the photo-conductor drum 1, the registration roller being contacted with a slave roller. Also, reference numeral 20 denotes a paper output tray, and reference numeral 21 denotes a double-sided printing conveying roller for conveying the recording medium onto the conveying path B when the recording medium is inserted through an exhaust port of the paper output tray 20 for the second printing in the double-sided printing.

And reference numeral 22 denotes toner supply bias voltage control means for applying a toner supply bias voltage that is convolution of DC component and AC component to the toner supply roller 7. Also, reference numeral 23 denotes developing bias voltage control means for applying a developing bias voltage that is a constant DC voltage to the developing roller 6. The developing bias voltage control means 23 and the toner supply bias voltage control means 22 cooperate to make the control.

The developing bias voltage control means 23 controls the developing bias voltage to be at least 100V or greater, and the toner supply bias voltage control means controls the DC component voltage of the toner supply bias voltage to be greater than or equal to this developing bias voltage in accordance with the control of this developing bias voltage. Further, the toner supply bias voltage control means 22 controls the peak-to-peak amplitude (hereinafter amplitude [P−P](V)) of the AC component of the toner supply bias voltage to be smaller than the DC component, and slightly greater than a potential difference in the DC component between the developing bias voltage and the toner supply bias voltage. Under the cooperative control of the developing bias voltage control means 23 and the toner supply bias voltage control means 22, it is possible to effectively convey the toner to the developing roller 6 and scrape off the unconsumed toner. The toner supply roller 7 may be grounded, or have any other control means for applying only the DC voltage, whereby the same effect is obtained.

In FIG. 1, reference numeral 24 denotes transfer bias voltage control means that is a feature of the embodiment 1. The transfer bias voltage control means 24 applies a voltage having the opposite polarity (positive) to the toner 9, which is convolution of DC component and AC component, to transfer the toner image on the photo-conductor drum 1. The details thereof will be described below with reference to FIG. 2 and FIGS. 3A and 3B. In FIG. 2, reference numeral 9a denotes fine particle having the opposite polarity (positive) to the toner 9, reference numeral 24a denotes a DC power supply controlled by the transfer bias voltage control means 24, and reference numeral 24b denotes an AC power supply controlled by the transfer bias voltage control means 24. Also, reference numeral 25 denotes the recording medium such as paper.

In the embodiment 1, the polarity of the toner 9 is negative, and the polarity of the photo-conductor drum 1 and the transfer roller 13 is positive. Also, the polarity of fine particle 9a is positive. The toner 9 is deposited on the photo-conductor drum 1 to form an electrostatic latent image that is transferred onto the recording medium 25, but the particles having large mass (such as toner charged in opposite polarity) are not deposited, or rarely deposited, on the photo-conductor drum 1 and the recording medium 25. However, the fine particles 9a such as the fractured toner 9 or its chip are subjected to a physical force other than an electrostatic force such as Van der Waals force, and deposited on the photo-conductor drum 1 and transferred onto the recording medium 25. In the embodiment 1, the center particle diameter of the toner 9 is roughly from 10 μm to 12 μm, and the size of fine particles 9a is much smaller.

In FIG. 3B, a DC transfer bias voltage is applied conventionally. A predetermined uniform electric field having less variation from the transfer roller 13 to the photo-conductor drum 1 is applied to the toner 9 and fine particles 9a deposited on the photo-conductor drum 1, so that the toner 9 is transferred onto the recording medium. At this time, the physical force, in addition to the electric force, is applied to the fine particles 9a having opposite polarity, so that this physical force overcomes the electrostatic force to cause some of the fine particles 9a to be transferred and deposited on the recording medium.

However, when the transfer bias voltage control means 24 applies a transfer bias voltage that is convolution of DC component and AC component, as shown in FIG. 3A, electric charges migrate in both the front and back directions (bi-direction) across the recording medium 25 due to polarization occurring on the front and back surfaces of the recording medium 25, causing the electric field between the transfer roller 13 and the photo-conductor drum 1 to be varied, and when the electric field in the reverse direction is formed due to the AC component, the electrostatic force acts as a resistive force in the reserve direction against the physical force acting on the fine particles 9a having opposite polarity.

Therefore, the fine particles 9a of the fractured toner 9 or its chip may not be dropped away from the photo-conductor drum 1, or can be restored even if they are dropped away. Thereby, the fine particles 9a can be prevented from being transferred onto the recording medium 25. Also, the fine particles 9a are prevented from floating and adhering to the non-image area to cause fogging, after they are dropped away from the photo-conductor drum 1. However, in the embodiment 1, the transfer bias voltage itself is totally a positive value though the electric field is changed by the AC component, whereby an electric force toward the transfer roller 13 can be applied to the toner 9. Accordingly, the white patch, transfer unevenness or fogging does not occur to degrade the print quality and lower the transfer efficiency, although they occurred conventionally.

By the way, the image forming apparatus of the embodiment 1 as described above operates as follows. The pickup roller 18 picks up the recording medium one by one from the paper feed tray 17 and carries in the recording medium onto the conveying path A, so that the recording medium is conveyed to the position of the registration roller 19a by the conveying rollers 19. When the toner image reaches a contact part between the transfer roller 13 and the photo-conductor drum 1 along with the rotation of the photo-conductor drum 1, the recording medium is controlled to reach this contact part in perfect timing for the toner image by the registration roller 19a. A transfer bias voltage having opposite polarity to the toner 9 is applied to the transfer roller 13, so that the toner image on the photo-conductor drum 1 is transferred onto the recording medium due to an electrostatic force and so on. Thereafter, the recording medium is conveyed to the fixing device 14, where the toner image is fixed by heat and pressure of the heat roller 15 and the pressure roller 16, and exhausted onto the paper output tray 20.

Thus, to examine the particulars of the control of the transfer bias voltage that is convolution of DC component and AC component, the print quality was evaluated by changing the developing bias voltage X(V), the AC component frequency f(Hz) and the amplitude [P−P](V). At first, a suitable range of rubber hardness of the transfer roller is obtained from the viewpoint of the transfer efficiency, and the developing bias voltage X(V), the AC component frequency f(Hz) and the amplitude [P−P](V) were changed with this rubber hardness as a parameter. The nip width is suitably from 1 mm to 20 mm, as described above, but fixed at 3 mm in this embodiment 1. And the print quality was evaluated based on the occurrence situation of fogging, image quality such as white patch and transfer unevenness, and contamination of the transfer roller. The evaluation was performed visually. The evaluation was given at three grades of A (good), B (acceptable), and C (no good). The temperature and humidity were in the ordinary temperature (room temperature) and ordinary humidity environment.

In FIG. 4, the rubber hardness of the transfer roller is Asker C. The single-sided printing was performed at a transfer bias voltage of 1 KV, in which the frequency f(Hz) was 1000 Hz and the AC component amplitude [P−P](V) was 500V. In FIG. 4, the transfer efficiency rises rapidly from the position of the rubber hardness of 10° and reaches 93% at 60°. And the transfer efficiency is kept at 93% to 94% up to near the rubber hardness of 60°, indicates about 91% at the rubber hardness of 70°, and indicates 85% near the rubber hardness of 75°. Table 1 lists the results of this experiment. According to FIG. 4 and Table 1, the rubber hardness of the transfer roller is suitably from 10° to 60° in Asker C, based on the evaluation of this experiment, to improve the print quality.

TABLE 1

| Transfer | | | NIP | Transfer | | | |
|---|---|---|---|---|---|---|---|
| voltage: X | Frequency: f | Amplitude: | width | efficiency | | Image | Contamination of |
| (V) | (Hz) | P-P (V) | (mm) | (%) | Fogging | quality | transfer roller |
| 300 | 100 | 500 | 3 | 70 | B | B | B |
| 400 | 100 | 500 | 3 | 72 | B | B | B |
| 500 | 500 | 500 | 3 | 93 | A | A | A |
| 1000 | 500 | 500 | 3 | 94 | A | A | A |
| 1500 | 500 | 500 | 3 | 94 | A | A | A |
| 2000 | 1000 | 500 | 3 | 94 | A | A | A |
| 2500 | 1000 | 500 | 3 | 94 | A | A | A |
| 3000 | 1000 | 500 | 3 | 93 | A | A | A |
| 3500 | 1000 | 500 | 3 | 94 | A | A | A |
| 4000 | 1000 | 500 | 3 | 94 | A | A | A |
| 4500 | 1000 | 500 | 3 | 92 | A | A | A |
| 5000 | 1000 | 500 | 3 | 92 | A | A | A |
| 5500 | 1000 | 500 | 3 | 90 | A | A | A |
| 6000 | 1000 | 500 | 3 | 90 | A | A | A |
| 6500 | 2000 | 500 | 3 | 83 | B | B | B |
| 7000 | 2000 | 500 | 3 | 80 | B | B | B |
| 7500 | 2000 | 500 | 3 | 70 | B | B | B |

Next, when the developing bias voltage X(V), the AC component frequency f(Hz) and the amplitude [P−P](V) are changed with the rubber hardness of the transfer efficiency as a parameter, the results are shown below. This is also the case of single-sided printing. Table 2 lists the results where the rubber hardness of the transfer roller is 20° in Asker C.

TABLE 2

| Transfer | | | NIP | Transfer | | | |
|---|---|---|---|---|---|---|---|
| voltage: X | Frequency: f | Amplitude: | width | efficiency | | Image | Contamination of |
| (V) | (Hz) | P-P (V) | (mm) | (%) | Fogging | quality | transfer roller |
| 300 | 100 | 500 | 3 | 70 | B | B | B |
| 400 | 100 | 500 | 3 | 70 | B | B | B |
| 500 | 500 | 500 | 3 | 90 | A | A | A |
| 1000 | 500 | 500 | 3 | 91 | A | A | A |
| 1500 | 500 | 500 | 3 | 90 | A | A | A |
| 2000 | 1000 | 500 | 3 | 90 | A | A | A |
| 2500 | 1000 | 500 | 3 | 90 | A | A | A |
| 3000 | 1000 | 500 | 3 | 91 | A | A | A |
| 3500 | 1000 | 500 | 3 | 91 | A | A | A |
| 4000 | 1000 | 500 | 3 | 91 | A | A | A |
| 4500 | 1000 | 500 | 3 | 90 | A | A | A |
| 5000 | 1000 | 500 | 3 | 89 | A | A | A |
| 5500 | 1000 | 500 | 3 | 89 | A | A | A |
| 6000 | 1000 | 500 | 3 | 88 | A | A | A |
| 6500 | 2000 | 500 | 3 | 82 | B | B | B |
| 7000 | 2000 | 500 | 3 | 80 | B | B | B |
| 7500 | 2000 | 500 | 3 | 65 | B | C | C |

Also, Table 3 lists the results where the rubber hardness of the transfer roller is 400 in Asker C. This is also the case of single-sided printing.

TABLE 3

| Transfer | | | NIP | Transfer | | | |
|---|---|---|---|---|---|---|---|
| voltage: X | Frequency: f | Amplitude: | width | efficiency | | Image | Contamination of |
| (V) | (Hz) | P-P (V) | (mm) | (%) | Fogging | quality | transfer roller |
| 300 | 100 | 500 | 3 | 75 | B | B | B |
| 400 | 100 | 500 | 3 | 76 | B | B | B |
| 500 | 500 | 500 | 3 | 92 | A | A | A |
| 1000 | 500 | 500 | 3 | 93 | A | A | A |
| 1500 | 500 | 500 | 3 | 93 | A | A | A |
| 2000 | 1000 | 500 | 3 | 93 | A | A | A |
| 2500 | 1000 | 500 | 3 | 94 | A | A | A |
| 3000 | 1000 | 500 | 3 | 93 | A | A | A |
| 3500 | 1000 | 500 | 3 | 94 | A | A | A |
| 4000 | 1000 | 500 | 3 | 94 | A | A | A |
| 4500 | 1000 | 500 | 3 | 93 | A | A | A |
| 5000 | 1000 | 500 | 3 | 94 | A | A | A |
| 5500 | 1000 | 500 | 3 | 94 | A | A | A |
| 6000 | 1000 | 500 | 3 | 93 | A | A | A |
| 6500 | 2000 | 500 | 3 | 85 | B | B | B |
| 7000 | 2000 | 500 | 3 | 80 | B | B | B |
| 7500 | 2000 | 500 | 3 | 76 | B | B | B |

Further, Table 4 lists the results where the rubber hardness of the transfer roller is 60° in Asker C. This is the case of single-sided printing.

TABLE 4

| Transfer | | | NIP | Transfer | | | |
|---|---|---|---|---|---|---|---|
| voltage: X | Frequency: f | Amplitude: | width | efficiency | | Image | Contamination of |
| (V) | (Hz) | P-P (V) | (mm) | (%) | Fogging | quality | transfer roller |
| 300 | 100 | 500 | 3 | 73 | B | B | B |
| 400 | 100 | 500 | 3 | 74 | B | B | B |
| 500 | 500 | 500 | 3 | 90 | A | A | A |
| 1000 | 500 | 500 | 3 | 92 | A | A | A |
| 1500 | 500 | 500 | 3 | 92 | A | A | A |
| 2000 | 1000 | 500 | 3 | 91 | A | A | A |
| 2500 | 1000 | 500 | 3 | 91 | A | A | A |
| 3000 | 1000 | 500 | 3 | 92 | A | A | A |
| 3500 | 1000 | 500 | 3 | 92 | A | A | A |
| 4000 | 1000 | 500 | 3 | 93 | A | A | A |
| 4500 | 1000 | 500 | 3 | 90 | A | A | A |
| 5000 | 1000 | 500 | 3 | 92 | A | A | A |
| 5500 | 1000 | 500 | 3 | 91 | A | A | A |
| 6000 | 1000 | 500 | 3 | 90 | A | A | A |
| 6500 | 2000 | 500 | 3 | 85 | B | B | B |
| 7000 | 2000 | 500 | 3 | 80 | B | B | B |
| 7500 | 2000 | 500 | 3 | 76 | B | B | B |

According to Tables 2 to 4, when the transfer voltage X(V) is from 500V to 6000V, the frequency f(Hz) is from 500 Hz to 1000 Hz, and the amplitude [P−P](V) is 500V, the transfer efficiency is as high as about 90%, and the fogging, white patch or transfer unevenness, and the contamination of the transfer roller are small. If the amplitude [P−P](V) exceeds double the absolute value of transfer voltage X(V), the electric field between the transfer roller 13 and the photo-conductor drum 1 is changed in the direction and varied to impede the transfer of the negatively charged toner 9 itself, and can not be employed. Accordingly, the amplitude [P−P](V)≦2|X(V)| is a condition for not degrading the print quality. Herein, |X(V)| indicates the absolute value of X(V).

The image forming apparatus of the embodiment 1 does not set the conditions minutely according to an environmental change and properly use the constant current control and the constant voltage control to keep the print quality, as conventionally, but applies a convolution of AC component and DC component to secure the print quality owing to its relation and the action of AC component. Therefore, the control is facilitated, and the print quality can be securely improved. Though not displayed here, even when the frequency f(Hz) is changed in a wider range from 50 Hz to 5000 Hz, the image forming apparatus can be provided in which the fogging, white patch and transfer unevenness are relatively small and the contamination of the transfer roller is small by choosing the transfer voltage X(V) and the amplitude [P−P](V).

In this manner, the image forming apparatus of the embodiment 1 can provide the excellent print quality in which the transfer unevenness, white patch and fogging are small because the transfer bias voltage is convolution of DC component and AC component. Also, when the DC component is constant voltage X(V), and the AC component has frequency f(Hz) and the amplitude [P−P](V), the transfer unevenness, white patch and fogging can be securely prevented under the conditions where 500V≦|X(V)|≦6000V, 500 Hz≦f(Hz)≦1000 Hz, and [P−P](V)≦2|X|.

### Embodiment 2

Next, an image forming apparatus according to an embodiment 2 of the present invention, and more particularly an image forming apparatus capable of double-sided printing, will be described below in detail. While the single-sided printing of the image forming apparatus capable of double-sided printing has been described in the embodiment 1, the double-sided printing will be described in the embodiment 2. Accordingly, the image forming apparatuses of the embodiments 1 and 2 have the same constitution, in which the same parts are denoted by the same reference numerals, and not described here.

The image forming apparatus of the embodiment 2 can perform the double-sided printing in which the initial (first) printing is made on the conveying path A as shown in FIG. 1, the recording medium exhausted onto the paper output tray is reversed and inserted, and then conveyed on the conveying path B, and the second printing is made on the conveying path A again.

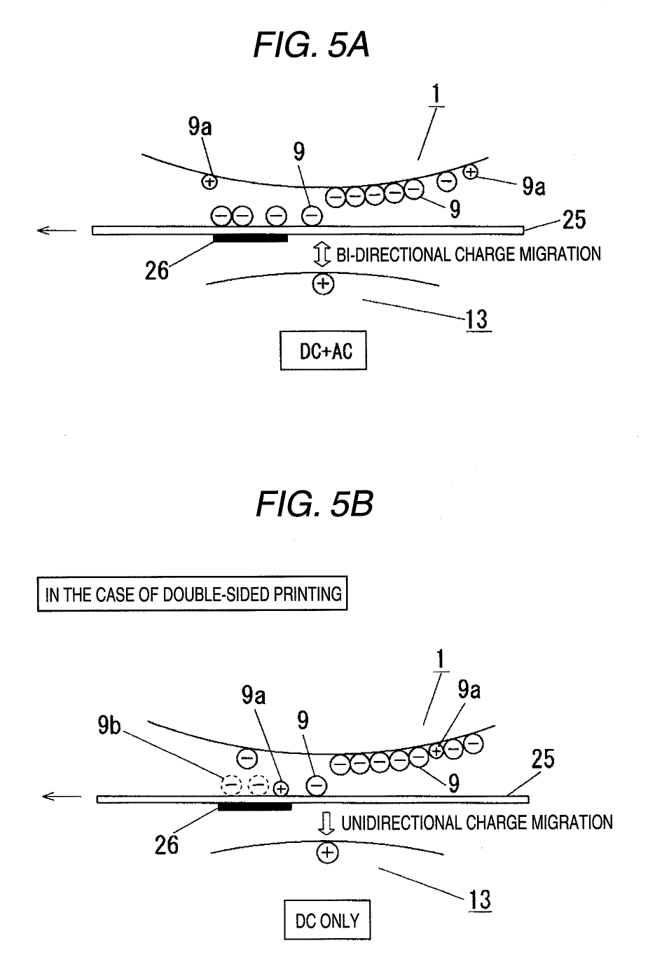

FIG. 5A is an explanatory view for explaining the operation when a transfer bias voltage that is convolution of DC component and AC component is applied to the image forming apparatus according to the embodiment 2 of the invention, and FIG. 5B is an explanatory view for explaining the operation when a transfer bias voltage of DC component is applied to the image forming apparatus of FIG. 5A.

By the way, when the double-sided printing is performed, the side of the recording medium on which the image is fixed by the first printing is reversed, and the toner image is transferred. Accordingly, the recording medium 25 to be conveyed has the toner 9 fixed by the first printing on the back surface, in which the toner 9 (image area) fixed by the first transfer may change the electric field for the transfer in the second printing.

That is, the dielectric constant is lower due to the fixed toner 9 in the image area, and the polarizability of the recording medium 25 is lower, so that the electric field strength between the transfer roller 13 and the photo-conductor drum 1 falls. Accordingly, when only the DC voltage is applied, the electric field is insufficient in the image area where the toner is fixed in the first printing, so that the toner 9 to be moved and deposited is not transferred, and the small fine particles 9a such as fractured toner 9 or its chip may adhere, as shown in FIG. 5B. In FIG. 5B, reference numeral 9b denotes the toner to be essentially transferred, but actually not transferred. Also, reference numeral 26 denotes the image area where the toner 9 is fixed in the first printing. The other area than the image area is the non-image area.

However, in the embodiment 2, when the transfer bias voltage control means 24 applies a transfer bias voltage that is convolution of DC component and AC component, as shown in FIG. 5A, the electric field between the transfer roller 13 and the photo-conductor drum 1 is varied alternately, whether the image area or the non-image area, even if the polarizability of the recording medium 25 falls. The electric fields for the image area and the non-image area in the first printing are averaged, whereby there is a smaller difference in the electric field between both on average, so that the transfer efficiency of the already printed image area part is not lower than the transfer efficiency of the non-image area part. The state of the first printing ranges from duty 0% to 100%, whereby even if any printing density occurs on the first printing face, the transfer unevenness is averaged by combining the AC component at the second time of transfer, so that the smooth transfer can be achieved without problem.

Thus, in the embodiment 2, the print quality was evaluated by changing the developing bias voltage X(V), the AC component frequency f(Hz) and the amplitude [P−P](V). The rubber hardness of the transfer roller was changed as a parameter. The nip width was 3 mm. The print quality was evaluated based on the occurrence situation of fogging, image quality of white patch and transfer unevenness, and contamination of the transfer roller, like the embodiment 1. The evaluation was performed visually. The evaluation was given at three stages of O, Δ and x. Table 5 lists the results in which the rubber hardness of the transfer roller is 20° in Asker C in the double-sided printing.

TABLE 5

| Transfer | | | NIP | Transfer | | | |
|---|---|---|---|---|---|---|---|
| voltage: X | Frequency: f | Amplitude: | width | efficiency | | Image | Contamination of |
| (V) | (Hz) | P-P (V) | (mm) | (%) | Fogging | quality | transfer roller |
| 300 | 100 | 500 | 3 | 68 | C | B | C |
| 400 | 100 | 500 | 3 | 74 | B | B | B |
| 500 | 500 | 500 | 3 | 89 | A | A | A |
| 1000 | 500 | 500 | 3 | 91 | A | A | A |
| 1500 | 500 | 500 | 3 | 93 | A | A | A |
| 2000 | 1000 | 500 | 3 | 92 | A | A | A |
| 2500 | 1000 | 500 | 3 | 93 | A | A | A |
| 3000 | 1000 | 500 | 3 | 93 | A | A | A |
| 3500 | 1000 | 500 | 3 | 93 | A | A | A |
| 4000 | 1000 | 500 | 3 | 93 | A | A | A |
| 4500 | 1000 | 500 | 3 | 93 | A | A | A |
| 5000 | 1000 | 500 | 3 | 92 | A | A | A |
| 5500 | 1000 | 500 | 3 | 91 | A | A | A |
| 6000 | 1000 | 500 | 3 | 91 | A | A | A |
| 6500 | 2000 | 500 | 3 | 80 | B | B | B |
| 7000 | 2000 | 500 | 3 | 76 | C | C | B |
| 7500 | 2000 | 500 | 3 | 70 | C | C | C |

Also, Table 6 lists the results in which the rubber hardness of the transfer roller is 40° in Asker C in the double-sided printing.

TABLE 6

| Transfer | | | NIP | Transfer | | | |
|---|---|---|---|---|---|---|---|
| voltage: X | Frequency: f | Amplitude: | width | efficiency | | Image | Contamination of |
| (V) | (Hz) | P-P (V) | (mm) | (%) | Fogging | quality | transfer roller |
| 300 | 100 | 500 | 3 | 67 | C | B | C |
| 400 | 100 | 500 | 3 | 72 | B | C | B |
| 500 | 500 | 500 | 3 | 90 | A | A | A |
| 1000 | 500 | 500 | 3 | 90 | A | A | A |
| 1500 | 500 | 500 | 3 | 90 | A | A | A |
| 2000 | 1000 | 500 | 3 | 90 | A | A | A |
| 2500 | 1000 | 500 | 3 | 90 | A | A | A |
| 3000 | 1000 | 500 | 3 | 91 | A | A | A |
| 3500 | 1000 | 500 | 3 | 90 | A | A | A |
| 4000 | 1000 | 500 | 3 | 90 | A | A | A |
| 4500 | 1000 | 500 | 3 | 88 | A | A | A |
| 5000 | 1000 | 500 | 3 | 89 | A | A | A |
| 5500 | 1000 | 500 | 3 | 90 | A | A | A |
| 6000 | 1000 | 500 | 3 | 88 | A | A | A |
| 6500 | 2000 | 500 | 3 | 82 | B | B | B |
| 7000 | 2000 | 500 | 3 | 78 | C | C | B |
| 7500 | 2000 | 500 | 3 | 65 | C | C | C |

Further, Table 7 lists the results in which the rubber hardness of the transfer roller is 60° in Asker C in the double-sided printing.

TABLE 7

| Rubber | | | NIP | Transfer | | | |
|---|---|---|---|---|---|---|---|
| hardness | Frequency: f | Amplitude: | width | efficiency | | Image | Contamination of |
| (Asker°) | (Hz) | P-P (V) | (mm) | (%) | Fogging | quality | transfer roller |
| 5 | 1000 | 500 | 3 | 60 | B | B | B |
| 8 | 1000 | 500 | 3 | 65 | B | B | B |
| 9 | 1000 | 500 | 3 | 70 | A | A | A |
| 10 | 1000 | 500 | 3 | 93 | A | A | A |
| 15 | 1000 | 500 | 3 | 94 | A | A | A |
| 20 | 1000 | 500 | 3 | 94 | A | A | A |
| 30 | 1000 | 500 | 3 | 94 | A | A | A |
| 40 | 1000 | 500 | 3 | 94 | A | A | A |
| 50 | 1000 | 500 | 3 | 94 | A | A | A |
| 60 | 1000 | 500 | 3 | 93 | A | A | A |
| 65 | 1000 | 500 | 3 | 92 | A | A | A |
| 70 | 1000 | 500 | 3 | 91 | A | A | A |
| 75 | 1000 | 500 | 3 | 85 | A | A | B |

According to Tables 5 to 7, like the embodiment 1, when the transfer voltage X(V) is from 500V to 6000V, the frequency f(Hz) is from 500 Hz to 1000 Hz, and the amplitude [P−P](V) is 500V, the transfer efficiency is as high as about 90% or more, and the fogging, white patch or transfer unevenness, and the contamination of the transfer roller are small. If the amplitude [P−P](V) exceeds double the absolute value of the transfer voltage X(V), the electric field between the transfer roller 13 and the photo-conductor drum 1 is changed in the direction and varied to impede the transfer of the negatively charged toner 9 itself, and can not be employed. Accordingly, the amplitude [P−P](V)≦2|X(V)| is a condition for not degrading the print quality.

The image forming apparatus of the embodiment 2, like the embodiment 1, does not set the conditions minutely according to an environmental change and properly use the constant current control and the constant voltage control to keep the print quality, as conventionally, but applies a convolution of AC component and DC component to secure the print quality owing to its relation and the action of AC component. Therefore, the control is facilitated, and the print quality can be securely improved. And even when the frequency f(Hz) is changed from 50 Hz to 5000 Hz, the image forming apparatus can be provided in which the fogging, white patch and transfer unevenness are relatively small and the contamination of the transfer roller is small by choosing the transfer voltage X(V) and the amplitude [P−P](V).

The image forming apparatus of the embodiment 2 as described above operates in the double-sided printing as follows. The pickup roller 18 picks up the recording medium 25 one by one from the paper feed tray 17, and carries in the recording medium onto the conveying path A, so that the recording medium is conveyed to the position of the registration roller 19a by the conveying rollers 19. When the toner image reaches a contact part between the transfer roller 13 and the photo-conductor drum 1 along with the rotation of the photo-conductor drum 1, the recording medium 25 is controlled to reach this contact part in perfect timing for the toner image by the registration roller 19a. A transfer bias voltage having opposite polarity to the toner 9 is applied to the transfer roller 13, so that the toner image on the photo-conductor drum 1 is transferred onto the recording medium 25 due to an electrostatic force and so on. Thereafter, the recording medium 25 is conveyed to the fixing device 14, where the toner image is fixed by heat and pressure of the heat roller 15 and the pressure roller 16, and exhausted onto the paper output tray 20.

Thereafter, because of the double-sided printing, the recording medium is inserted manually or automatically through the exhaust opening of the paper output tray 20 for the second printing. At this time, the conveying roller 19 is controlled to be reversely rotated, whereby if the recording medium reaches the position of the conveying roller 21 for double-sided printing, the recording medium 25 is conveyed on the conveying path B due to a rotational force of the conveying roller 21 for double-sided printing. The recording medium is conveyed via the conveying path B to the position of the registration roller 19a again, so that the toner image on the photo-conductor drum 1 is transferred onto the back surface of the recording medium 25. Thereafter, the recording medium 25 is fixed in the fixing device 14, and outputted onto the paper output tray 20.

Incidentally, the image forming apparatus of the embodiment 2 has been described above, using mainly the monochrome image forming apparatus. The invention may be also applicable to a color image forming apparatus comprising the developer unit 12 having the toner bottles of yellow (Y), magenta (M), cyan (C) and black (K), which performs the printing repeatedly plural times in such a manner that the first printing is performed in yellow, the second printing is performed in magenta, third printing is performed in cyan and the fourth printing is performed in black. That is, in the repetitive transfer of four colors, the print quality may be degraded unless the electrostatic separation is securely controlled, but the image forming apparatus of the embodiment 2 can avoid this problem simply, and the color image forming apparatus is usable for the single-sided printing and double-sided printing. Especially in the double-sided printing of the color image forming apparatus, the print quality can be improved, unlike the conventional image forming apparatus.

In this manner, the image forming apparatus of the embodiment 2 can provide the excellent print quality in which the transfer unevenness, white patch and fogging that are more likely to occur in the double-sided printing are small, because the transfer bias voltage is convolution of DC component and AC component. Also, when the DC component is X(V), the AC component has frequency is f(Hz), and the amplitude is [P−P](V), the transfer unevenness, white patch and fogging can be securely prevented under the conditions where 500V≦|X(V)|≦6000V, 500 Hz≦f(Hz)≦1000 Hz, and [P−P](V)≦2|X|.

What is claimed is:

1. An image forming apparatus comprising:
an image bearing member configured to bear a toner image;
a transfer roller configured to be rotated in contact with said image bearing member, and to transfer the toner image borne on the image bearing member onto a recording medium, the recording medium being conveyed between the image bearing member and the transfer roller; and
controller configured to apply, to the transfer roller, a transfer bias voltage for transferring the toner image from the image bearing member onto the recording medium,
wherein said transfer bias voltage is convolution of DC component and AC component.

2. The image forming apparatus according to claim 1, wherein when the DC component is a voltage represented by a constant voltage X(V), and the AC component is a voltage represented by a frequency f(Hz) and an amplitude [P−P](V), the relations are the followings:
500V≦|X(V)|≦6000V
500 Hz≦f(Hz)≦1000 Hz, and
[P−P](V)≦2|X(V)|

3. The image forming apparatus according to claim 2, wherein the transfer roller is made of an elastic foam, in which the rubber hardness of the transfer roller is from 10° to 60° in Asker C.

4. The image forming apparatus according to claim 3, wherein the nip width between said image bearing member and said transfer roller is from 1 mm to 20 mm.

5. The image forming apparatus according to claim 1, wherein the controller applies, to the transfer roller, a transfer bias voltage that is convolution of DC component and AC component, when the printing is performed on the back face in the double-sided printing.

6. The image forming apparatus according to claim 1, wherein the toner of positive polarity and the toner of negative polarity are deposited on the image bearing member.

7. The image forming apparatus according to claim 6, wherein the toner of positive polarity deposited from said image bearing member onto the recording medium is restored to said image bearing member by the transfer bias voltage that is convolution of DC component and AC component.

8. The image forming apparatus according to claim 7, wherein the toner of negative polarity remains on said recording medium.
